(19) United States
(12) Patent Application Publication
(10) Pub. No.: US 2019/0344603 A1
(43) Pub. Date: Nov. 14, 2019

(54) MECHANICAL PENCIL

(71) Applicant: KOTOBUKI & CO., LTD., Kawagoe-shi (JP)

(72) Inventor: Tadashi KEDA, Kawagoe-shi (JP)

(21) Appl. No.: 16/520,092

(22) Filed: Jul. 23, 2019

Related U.S. Application Data
(63) Continuation of application No. PCT/JP2018/008885, filed on Mar. 8, 2018.

(30) Foreign Application Priority Data
Mar. 8, 2017 (JP) 2017-044160

(51) Int. Cl. B43K 21/16; B43K 21/22

(52) U.S. Cl. CPC B43K 21/16; B43K 21/22

(57) ABSTRACT

A mechanical pencil according to an embodiment includes a barrel; a chuck mechanism that is housed inside the barrel and that is capable of chucking and feeding out a writing lead for a mechanical pencil; a first cushion spring that has a prescribed setting load and elastically supports the chuck mechanism in an axial direction with respect to the barrel; and a second cushion spring that elastically supports the chuck mechanism in an axial direction with respect to the barrel, wherein the second cushion spring is elastically deformable due to the prescribed setting load of the first cushion spring.

### CROSS-REFERENCE TO RELATED APPLICATION

This application is based upon and claims the benefit of priority under 35 USC 119 of PCT Application No. PCT/JP2018/008885 filed on Mar. 8, 2018 (Earlier Application is Japanese Patent Application No. JP2017-044160), the entire disclosure of which, including the description, claims, drawings, and abstract, is incorporated herein by reference in its entirety.

### FIELD

This disclosure relates to a mechanical pencil that includes a chuck for chucking a writing lead for a mechanical pencil and that is capable of feeding out the writing lead for a mechanical pencil by a click operation.

### BACKGROUND

Conventionally, there is known a mechanical pencil comprising a lead tank slidably provided inside a barrel, a chuck fixed to a tip part of the lead tank, a chuck ring detachably fitted to the chuck, a sleeve provided between the barrel and the chuck, an elastic member abutting with the sleeve and being assembled so that a part thereof is assembled with press-fitting to the lead tank, and operating means which compresses the elastic member and makes the lead tank movable in an axial direction (for example, refer to Japanese Patent Application Laid-open No. H07-290880 (paragraphs 0006 and 0017)).

### DISCLOSURE

According to the mechanical pencil disclosed in Japanese Patent Application Laid-open No. H07-290880, a stroke for pushing out a slider can be sufficiently obtained with a simple structure which integrates a chuck fastening spring with a cushion spring into one body. However, conventionally, there is a need to provide a mechanical pencil that performs additional cushioning under a load equal to or lower than a setting load of a cushion spring.

This disclosure provides a mechanical pencil that performs additional cushioning under a load equal to or lower than a setting load of a cushion spring.

### SUMMARY

In an aspect of the present invention, a mechanical pencil includes a barrel, a chuck mechanism that is housed inside the barrel and that is capable of chucking and feeding out a writing lead for a mechanical pencil, a first cushion spring that has a prescribed setting load and elastically supports the chuck mechanism in an axial direction with respect to the barrel, and a second cushion spring that elastically supports the chuck mechanism in an axial direction with respect to the barrel, wherein the second cushion spring is elastically deformable due to the prescribed setting load of the first cushion spring.

A plurality of aspects of the present invention are capable of providing a mechanical pencil that performs additional cushioning under a load equal to or lower than a setting load of a cushion spring.

### BRIEF DESCRIPTION OF DRAWINGS

FIG. 1 is a partial sectional view illustrating a forward-side portion and a rearward-side portion while omitting an intermediate portion of a mechanical pencil according to an embodiment;

FIG. 2 is a front view of a sleeve of a mechanical pencil according to an embodiment; and

FIG. 3 is a diagram illustrating output load relative to displacement in a first cushion spring and a spring that is a composite of the first cushion spring and a second cushion spring of a mechanical pencil according to an embodiment.

### DESCRIPTION OF EMBODIMENTS

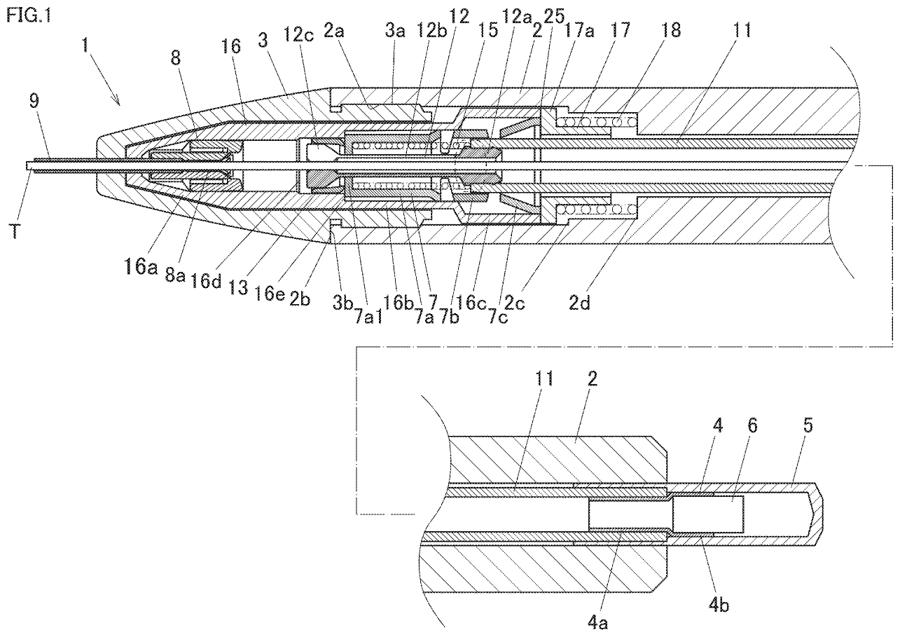

Hereinafter, a plurality of embodiments will be described with reference to the drawings. A mechanical pencil 1 according to the present embodiment illustrated in FIG. 1 is a rear end click-type mechanical pencil in which a writing lead T for a mechanical pencil is fed out and protrudes from a tip of a tip fitting 3 by a click operation on a click button 5. In the following description, a side on which the tip fitting 3 of the mechanical pencil 1 is arranged will be referred to as front and a side on which the click button 5 is arranged will be referred to as rear in a direction of a central axis (the axial direction) which extends in a longitudinal direction of the mechanical pencil 1.

The mechanical pencil 1 includes a barrel main body 2 with an approximately tubular shape and the tip fitting 3 with an approximately tapered tubular shape. A barrel is formed so as to include the barrel main body 2 and the tip fitting 3. The barrel main body 2 and the tip fitting 3 arranged to the front of the barrel main body 2 are assembled as an internal screw part 2a formed on an inner circumferential surface of a front end part of the barrel main body 2 and a external screw part 3a formed on an outer circumferential surface of a tubular part formed to the rear of the tip fitting 3 screw with each other.

The click button 5 formed in a bottomed tubular shape is detachably attached to a rear end of a lead tube 11 (to be described in detail later) arranged inside the barrel main body 2. An inner circumferential surface of a front end opening of the click button 5 is detachably fitted to an outer circumferential surface of the rear end of the lead tube 11. An outer circumferential surface of a front part of an eraser ferrule 4 formed in an approximately tubular shape is detachably fitted and assembled to an inner circumferential surface of the rear end of the lead tube 11. The eraser ferrule 4 has a forward-side small diameter part 4a and a rearward-side large diameter part 4b. An outer circumferential surface of an eraser 6 is detachably fitted and assembled to an inner circumferential surface of the large diameter part 4b of the eraser ferrule 4.

The lead tube 11 internally housing the writing lead T for a mechanical pencil is formed in an approximately tubular shape and arranged inside the barrel main body 2. A chuck 12 is assembled to a front part of the lead tube 11. The chuck 12 is formed so as to be capable of chucking the writing lead T for a mechanical pencil by chucking in a radial direction when each chuck piece formed by dividing a tip of the chuck 12 into three parts in a circumferential direction elastically deforms toward the central axis. The chuck 12 has a rear end base part 12a fixed by being inserted into the lead tube 11, a beam-like part 12b extending forward from the base part 12a, and a bulging part 12c formed at a front end of the beam-like part 12b. A chuck ring 13 is detachably fitted to an outer circumference of the bulging part 12c. A sleeve 7 is arranged at an outer circumference of a front part of the lead tube 11 and outer circumferences of the base part 12a and the beam-like part 12b of the chuck 12.

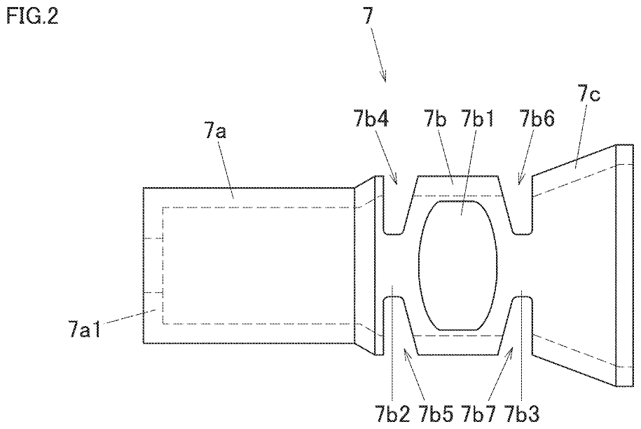

As illustrated in FIG. 2, the sleeve 7 is formed in an approximately tubular shape and has a tubular part 7a in a front part thereof, an elastic part 7b (the second cushion spring) formed to the rear of the tubular part 7a, and a tapered tubular part 7c formed to the rear of the elastic part 7b. The sleeve 7 is formed by injection molding using a resin material. The tubular part 7a of the sleeve 7 is formed in an approximately tubular shape having an annular wall 7a1 at a front end thereof. A connecting part with an approximately tapered tubular shape formed such that an inner diameter and an outer diameter thereof decrease from the rear toward the front is formed between the rear end of the tubular part 7a and the elastic part 7b. The tapered tubular part 7c in the rear part of the sleeve 7 is similarly formed in an approximately tapered tubular shape. The elastic part 7b is formed in an approximately tubular shape and an opening part 7b1, illustrated, is formed at two locations opposing each other in a radial direction on an outer circumferential surface of the elastic part 7b. Connecting parts 7b2 and 7b3 respectively extend in the axial direction from a rear end edge of the tubular part 7a and a front end edge of the tapered tubular part 7c corresponding to each opening part 7b1, and the tubular part 7a and the tapered tubular part 7c each connect with a portion of the elastic part 7b on an outer circumference of the opening part 7b1 via the connecting parts 7b2 and 7b3. In the circumferential direction of the elastic part 7b, the connecting parts 7b2 and 7b3 are formed sufficiently narrower than the opening part 7b1. Therefore, in the circumferential direction of the elastic part 7b, gap parts 7b4, 7b5, 7b6, and 7b7 being formed so as to make a notch extending in a circumferential direction are formed in portions adjacent to the connecting parts 7b2 and 7b3. The gap parts 7b4, 7b5, 7b6, and 7b7 are formed such that a beam-like part on an outer circumference of the opening part 7b1 adjacent to the gap parts 7b4, 7b5, 7b6, and 7b7 becomes a prescribed thin-wall part. With the sleeve 7 formed in this manner, when a compressive force is applied in the axial direction, the beam-like part on the outer circumference of the opening part 7b1 adjacent to the gap parts 7b4, 7b5, 7b6, and 7b7 is deflected, the connecting parts 7b2 and 7b3 approach each other, and a prescribed resilient force is generated. In addition, the sleeve 7 has elasticity that enables an original shape (free length) to be restored when the compressive force applied in the axial direction is removed.

As will be described in detail later, in the present embodiment, the sleeve 7 is assembled to the mechanical pencil 1 so as to create a state where the elastic part 7b that functions as the second cushion spring has a free length thereof. The second cushion spring has a function of adjusting, in a cushioning region where writing pressure lower than a setting load of a first cushion spring is applied, the writing pressure so as to equal writing pressure conforming to a second prescribed spring constant.

A chuck spring 15 that is a coil spring is assembled between the outer circumferential surface of the beam-like part 12b of the chuck 12 and the inner circumferential surface of the sleeve 7. A front end of the chuck spring 15 abuts with a rear surface of the annular wall 7a1 of the sleeve 7 and a rear end of the chuck spring 15 abuts with a front end surface of the lead tube 11. The chuck spring 15 is assembled in a state of being compressed in the axial direction between the sleeve 7 and the lead tube 11. Since the lead tube 11 and the chuck 12 are biased rearward with respect to the sleeve 7 due to a biasing force of the chuck spring 15, as illustrated, a rear end surface of the chuck ring 13 and a front surface of the annular wall 7a1 of the sleeve 7 abut with each other.

The mechanical pencil 1 according to the present embodiment includes a guide tube 16 that compresses a cushion spring 18, to be described in detail later, with a prescribed setting load. The guide tube 16 is formed in an approximately tubular shape and has a tapered tubular part 16a in a front part thereof, a large diameter tubular part 16c in a rear part thereof, and a small diameter tubular part 16b formed between the tapered tubular part 16a and the large diameter tubular part 16c. An outer diameter and an inner diameter of the large diameter tubular part 16c are respectively larger than an outer diameter and an inner diameter of the small diameter tubular part 16b. The guide tube 16 is inserted into the tip fitting 3 and, together with the large diameter tubular part 16c, a rear part of the small diameter tubular part 16b protrudes rearward from a rear end of the tip fitting 3. The guide tube 16 is biased toward the front in the axial direction by the cushion spring 18 and assembled so as to abut with the tip fitting 3. A step part 16d having an annular abutting surface that abuts with a front end surface of the chuck ring 13 having moved forward is formed on an inner circumferential surface of the guide tube 16. A step part 16e having an annular abutting surface that abuts with a front end surface of the sleeve 7 is further formed on the inner circumferential surface of the guide tube 16 to the rear of the step part 16d.

The rear end of the guide tube 16 abuts with a front end of a spring receiving member 17. The spring receiving member 17 is formed in an approximately tubular shape having a flange part 17a at a front end thereof, and is arranged in the radial direction between an outer circumferential surface of the lead tube 11 and an inner circumferential surface of the barrel main body 2. The cushion spring 18 to be described in detail later is assembled by being compressed by a prescribed setting load in the axial direction by the guide tube 16 and the spring receiving member 17. On the other hand, as described earlier, the sleeve 7 is assembled inside the guide tube 16 without being compressed in the axial direction in a state where the elastic part 7b of the sleeve 7 retains its free length. In order to enable the elastic part 7b of the sleeve 7 to have its free length, a rear end surface of the guide tube 16 that abuts with a front end surface of the spring receiving member 17 functions as a supporting part 25 for providing support in the axial direction so that the setting load of the cushion spring 18 is not applied to the elastic part 7b of the sleeve 7. A rear end surface of the flange part 17a of the spring receiving member 17 is arranged separated by a prescribed interval from a step part 2c which has an annular surface facing the front and which is formed on the inner circumferential surface of the barrel main body 2 so that a prescribed cushion stroke is obtained.

The cushion spring 18 (the first cushion spring) that is a coil spring is assembled compressed in the axial direction by a prescribed setting load between the rear end surface of the flange part 17a of the spring receiving member 17 and an annular surface of a step part 2d formed on the inner circumferential surface of the barrel main body 2. In this case, a configuration is adopted in which the second spring constant of the elastic part 7b of the sleeve 7 which constitutes the second cushion spring described earlier has a lower value than the first spring constant of the cushion spring 18 which constitutes the first cushion spring. Adopting such a configuration enables cushioning by the elastic part 7b of the sleeve 7 to be performed at lower writing pressure than writing pressure at which the cushion spring 18 is actuated.

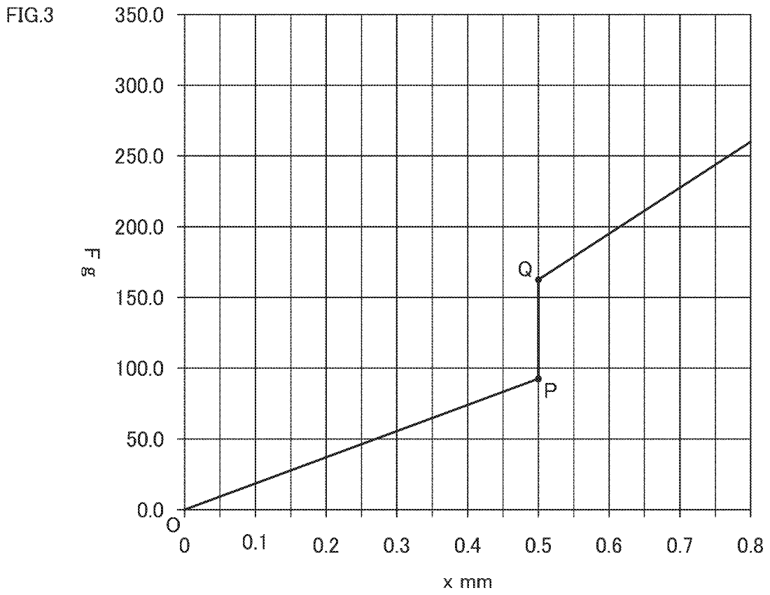

While the elastic part 7b of the sleeve 7 which constitutes the second cushion spring is assembled so as to have a free length, the cushion spring 18 which constitutes the first cushion spring is configured so as to have a prescribed setting load. Adopting such a configuration enables a user to, by sensing the prescribed setting load of the cushion spring 18 which is reflected onto writing pressure, clearly distinguish between a cushioning region (a stroke actuating region) of the elastic part 7b of the sleeve 7 which is lower than the prescribed setting load and a cushioning region of the cushion spring 18 which is higher than the setting load. Therefore, in the cushioning region of the elastic part 7b of the sleeve 7 which is lower than the prescribed setting load, the user can actively perform cushioning by the elastic part 7b of the sleeve 7 without fear of breakage of the writing lead T for a mechanical pencil due to writing pressure and can perform writing at prescribed stable writing pressure that conforms to, for example, the second spring constant illustrated in FIG. 3. On the other hand, in the cushioning region of the cushion spring 18 which is higher than the prescribed setting load, the user can perform writing at desired high writing pressure while preventing breakage of the writing lead T for a mechanical pencil due to excessive writing pressure. Furthermore, since the present embodiment is configured so that the first spring constant of the cushion spring 18 and the second spring constant of the elastic part 7b of the sleeve 7 have different values, the user can distinguish between the respective cushioning regions by sensing the difference between the first and second spring constants due to writing pressure.

A slider 8 is assembled so as to be movable back and forth inside the guide tube 16 to the front of the chuck 12. A lead guide 9 that protrudes forward by penetrating the guide tube 16 and the tip fitting 3 is fixed to a front part of the slider 8. An outer circumferential surface of a rear part of the slider 8 comes into sliding contact with the inner circumferential surface of the guide tube 16 and generates prescribed resistance capable of stopping the slider 8 at an arbitrary position in the axial direction. A configuration is adopted in which the writing lead T for a mechanical pencil is insertable into the slider 8 and the writing lead T for a mechanical pencil is clamped by a prescribed clamping force by a motion breaker 8a formed on an inner circumferential surface of the slider 8.

A chuck mechanism capable of chucking and feeding out the writing lead T for a mechanical pencil is configured so as to include the chuck 12, the chuck ring 13, the sleeve 7, and the chuck spring 15, and is housed inside the barrel. The cushion spring 18 elastically supports the chuck mechanism in the axial direction with respect to the barrel at a prescribed setting load and the first spring constant. By having the cushion spring 18 elastically support the chuck mechanism, breakage of the writing lead T for a mechanical pencil being chucked by the chuck mechanism can be prevented even when excessive writing pressure is applied to the writing lead T for a mechanical pencil.

Feed-out of the writing lead T for a mechanical pencil by the mechanical pencil 1 will be described. Due to a click operation involving clicking the click button 5, the lead tube 11, the chuck 12 to which the chuck ring 13 is fitted, and the writing lead T for a mechanical pencil chucked by the chuck 12 move forward against a biasing force of the chuck spring 15. When the slider 8 and the lead guide 9 are receded, the slider 8 and the lead guide 9 are also pressed by the chuck 12 and move forward together with the writing lead T for a mechanical pencil. Once the chuck 12 and the chuck ring 13 have moved by a prescribed interval, the front end surface of the chuck ring 13 engages with the abutting surface of the step part 16d formed on the inner circumferential surface of the guide tube 16, and the chuck ring 13 disengages rearward from the bulging part 12c of the chuck 12. Once the chuck ring 13 disengages, each chuck piece of the chuck 12 opens outward in the radial direction due to elasticity and the writing lead T for a mechanical pencil is released. The writing lead T for a mechanical pencil is fed out by a prescribed feed-out amount per one click operation in the mechanical pencil 1 and is then released. When the click button 5 is released from being clicked and the chuck mechanism is released from the click operation, the chuck 12 and the chuck ring 13 recede without the writing lead T for a mechanical pencil being clamped by the motion breaker 8a of the slider 8 at a fed-out and released position and once again chuck the writing lead T for a mechanical pencil at a position to the rear of the position prior to the click operation.

Writing with the mechanical pencil 1 can be performed in a state where a prescribed amount of the writing lead T for a mechanical pencil is protruding from the lead guide 9. A load (so-called writing pressure) generated in the axial direction by writing is applied to the writing lead T for a mechanical pencil, the chuck 12 that chucks the writing lead T for a mechanical pencil, and the chuck ring 13 and the sleeve 7. When the writing pressure exceeds a prescribed load, the cushion spring 18 and the elastic part 7b of the sleeve 7 elastically deform and cushioning is performed which involves the writing lead T for a mechanical pencil, the chuck 12, the chuck ring 13, and the sleeve 7 receding rearward.

Cushioning will now be described in detail. First, when writing pressure lower than the prescribed setting load of the cushion spring 18 (the first cushion spring) is applied to the writing lead T for a mechanical pencil, the elastic part 7b (the second cushion spring) of the sleeve 7 with a lower spring constant than the cushion spring 18 compresses before the cushion spring 18 does. As described earlier, the elastic part 7b of the sleeve 7 elastically deforms in a direction of compression by a smaller load than the prescribed setting load of the cushion spring 18. The writing lead T for a mechanical pencil recedes by a prescribed amount in accordance with the second spring constant of the elastic part 7b of the sleeve 7 together with the chuck 12, the chuck ring 13, the lead tube 11, and the tubular part 7a of the sleeve 7. In this manner, the mechanical pencil 1 performs a first cushioning.

In the present embodiment, the elastic part 7b of the sleeve 7 which has a relatively low spring constant and which is assembled at a free length is arranged so as to stack in the axial direction with the cushion spring 18 which has a relatively high spring constant and which outputs a prescribed setting load. When adopting such a configuration, even when writing pressure is not applied to a spring (the elastic part 7b of the sleeve 7) with a relatively low spring constant, it is conceivable that the spring with a relatively low spring constant may constantly elastically deform due to a biasing force (the setting load) of a spring (the cushion spring 18) with a relatively high spring constant. However, in the present embodiment, as described earlier, since the biasing force of the cushion spring 18 is supported by the supporting part 25 of the guide tube 16, a configuration can be adopted in that the elastic part 7b of the sleeve 7 only elastically deforms when writing pressure is applied to the elastic part 7b of the sleeve 7.

When the writing pressure further increases and the elastic part 7b of the sleeve 7 is compressed until elastic deformation in the axial direction substantially stops, no additional cushioning is performed by the elastic part 7b of the sleeve 7. In this case, cushioning is performed which involves the writing lead T for a mechanical pencil, the chuck 12, the chuck ring 13, the lead tube 11, and the compressed and elastically deformed sleeve 7 and spring receiving member 17 receding against the cushion spring 18 that outputs the prescribed setting load.

A specific example of a relationship between writing pressure (load) and displacement in cushioning of the mechanical pencil 1 will now be illustrated in FIG. 3. When the writing lead T for a mechanical pencil is subjected to writing pressure, initially, the elastic part 7b that is the second cushion spring is actuated and exhibits a behavior illustrated from point O to point P in FIG. 3. In other words, up to writing pressure of approximately 90 g, the elastic part 7b compresses by 0.5 mm. In this case, as illustrated from point P to point Q in FIG. 3, applying further writing pressure does not generate a cushion stroke (displacement) until approximately 170 g. At this point, after exceeding the initial cushioning region (0 g to approximately 90 g) in which the elastic part 7b of the sleeve 7 that is the second cushion spring is actuated, the user can sense through writing pressure that the setting load (approximately 170 g) of the cushion spring 18 that is the first cushion spring has been reached.

When writing pressure is further applied and the writing pressure exceeds approximately 170 g, the cushion spring 18 that is the first cushion spring is actuated and exhibits a behavior of point Q and thereafter. As illustrated, performing cushioning so that writing pressure ranges from 250 g to 350 g when a stroke of 0.8 mm is performed is favorable in terms of using the mechanical pencil 1. More favorably, cushioning is performed so that writing pressure ranges from 280 g to 320 g when a stroke of 0.8 mm is performed and, most favorably, cushioning is performed so that writing pressure ranges from 290 g to 310 g when a stroke of 0.8 mm is performed. Since the first spring constant of the cushion spring 18 is higher than the second spring constant of the elastic part 7b of the sleeve 7, writing pressure (output of spring) increases more abruptly with respect to an increase in displacement in the cushioning region in which the cushion spring 18 is actuated.

In this manner, the mechanical pencil 1 can be configured so that the user can get a soft feel due to the second cushion spring in initial cushioning with low writing pressure and, once prescribed writing pressure is exceeded, the user can sense that a cushioning limit is approaching due to cushioning of the first cushion spring that has a hard feel.

While an embodiment has been described above, it is to be understood that the present invention is not limited to the present embodiment and can be implemented with a wide variety of modifications. For example, while it has been described in the present embodiment that the second cushion spring is arranged so as to stack with the first cushion spring to the front of the first cushion spring in the axial direction, in another embodiment, the second cushion spring may be arranged so as to stack with the first cushion spring to the rear of the first cushion spring in the axial direction. In yet another embodiment, the first cushion spring and the second cushion spring may be formed in a nested state of respectively having different dimensions in the radial direction and may be arranged so as to have portions that overlap with each other in the axial direction. In addition, while it has been described in the present embodiment that the second cushion spring is set so as to have a free length, in another embodiment, the second cushion spring may be assembled so as to have a prescribed setting load.

What is claimed is:

1. A mechanical pencil, including:
a barrel;
a chuck mechanism that is housed inside the barrel and that is capable of chucking and feeding out a writing lead for a mechanical pencil;
a first cushion spring that has a prescribed setting load and that elastically supports the chuck mechanism in an axial direction with respect to the barrel; and
a second cushion spring that elastically supports the chuck mechanism in an axial direction with respect to the barrel, wherein
the second cushion spring is elastically deformable due to the prescribed setting load of the first cushion spring.

2. The mechanical pencil according to claim 1, further including a supporting part that supports the prescribed setting load of the first cushion spring in the axial direction.

3. The mechanical pencil according to claim 1, wherein the second cushion spring is set so as to have a free length.

4. The mechanical pencil according to claim 2, wherein the second cushion spring is set so as to have a free length.
